(19) United States
(12) Patent Application Publication
(10) Pub. No.: US 2025/0182165 A1
(43) Pub. Date: Jun. 5, 2025

(54) AI Ticket Sales Engagement

(71) Applicant: Angel Studios, Inc., Provo, UT (US)

(72) Inventors: Jeffrey Harmon, Provo, UT (US); Neal Harmon, Provo, UT (US); Ajay Madhok, Provo, UT (US)

(21) Appl. No.: 18/964,839

(22) Filed: Dec. 2, 2024

Related U.S. Application Data
(60) Provisional application No. 63/605,480, filed on Dec. 2, 2023.

(51) Int. Cl. G06Q 30/0251

(52) U.S. Cl. CPC G06Q 30/0271

(57) ABSTRACT

A method and system for an AI-driven user interaction for exploring and/or purchasing tickets for a movie, concert, performance, or other event may comprise an AI model trained to interact from the perspective of a movie actor, band member, to help a user understand the potential performance, facilitate purchase of a ticket, and/or enhance the user's experience for exploring a ticket and/or purchasing a ticket.

### CROSS-REFERENCE TO RELATED APPLICATIONS

This application claims priority to U.S. Provisional Application No. 63/605,480, titled “AI Ticket Sales Engagement,” and filed on Dec. 2, 2023, and which is incorporated herein by reference in its entirety.

### BACKGROUND OF THE INVENTION

Marketing and promotion for sales of tickets to movies, sporting events, concerts, performing arts events, or other events requires presenting a promotional message/content to a potential consumer/purchaser. Such messaging/content is, however, often limited as being static and therefore somewhat sterile. One shortcoming may be that aspects of the event that may affect purchase decisions are not disclosed to the potential consumer/purchaser, or the messaging/content does not sufficiently engage the potential consumer/purchaser to elicit a purchase or even further steps toward a potential purchase. What is needed is a technology that better engages a potential consumer regarding purchasing tickets for an event.

### BRIEF SUMMARY OF THE INVENTION

A method and system for an AI-driven user interaction for exploring and/or purchasing tickets for a movie, concert, performance, or other event may comprise an AI model trained to interact from the perspective of a movie actor, band member, to help a user understand the potential performance, facilitate purchase of a ticket, and/or enhance the user's experience for exploring a ticket and/or purchasing a ticket.

### BRIEF DESCRIPTION OF THE DRAWINGS

FIG. 1 illustrates an exemplary user interface for triggering an AI-driven interaction as described herein.

FIG. 2 illustrates an exemplary user interface for triggering an AI-driven interaction as described herein.

FIGS. 3-9 show an exemplary AI-driven interaction at different points in time or different points of development of the interaction.

FIG. 10 shows a flowchart for an exemplary method as described herein.

### DETAILED DESCRIPTION OF THE INVENTION

A system and method are disclosed for an AI-driven interaction with a potential purchaser of tickets for a movie, performance, event.

Table of Reference Numbers from Drawings:

The following table is for convenience only and should not be construed to supersede any potentially inconsistent disclosure herein.

| Reference | |
|---|---|
| Number | Description |
| 100 | user interface |
| 110 | control element |
| 200 | user interface |
| 210 | control element |
| 300 | user interface |
| 1000 | exemplary method |
| 1010 | method step |
| 1020 | method step |
| 1030 | method step |
| 1040 | method step |

A system and method are disclosed for using AI (“artificial intelligence”) to improve and increase user/customer engagement when purchasing tickets online to events such as movies, sporting events, concerts, ballets, and/or any other events featuring or comprising performers. Performers could be humans, animals, cartoon characters, animations, virtual, characters, fictional characters, AI-generated characters, aliens, robots, etc.

In one embodiment, an AI model may be developed and tuned for a customer to have an interaction with a performer in an event or show to which the customer is purchasing (or considering purchasing) tickets.

For example, and more specifically, when a customer is purchasing tickets to a movie through a smartphone, computer, or other electronic device that uses an app, website, or other interface, the interface may present to the customer an opportunity to have a virtual AI-driven interaction with a star of the movie. The purpose of this engagement may be for an enjoyable interaction, as an opportunity to get a discount to the movie tickets, as an opportunity to learn more about the movie, or as a closely integrated part of the ticket-buying experience.

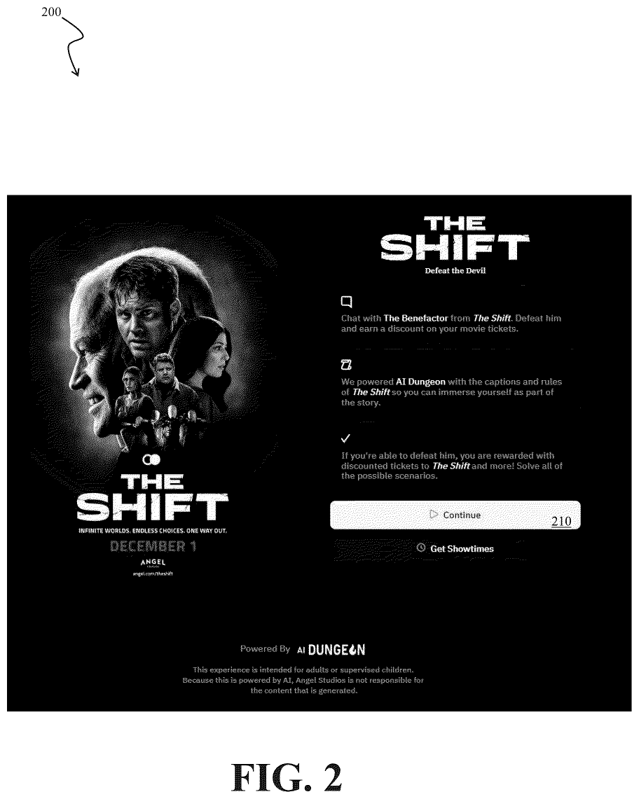

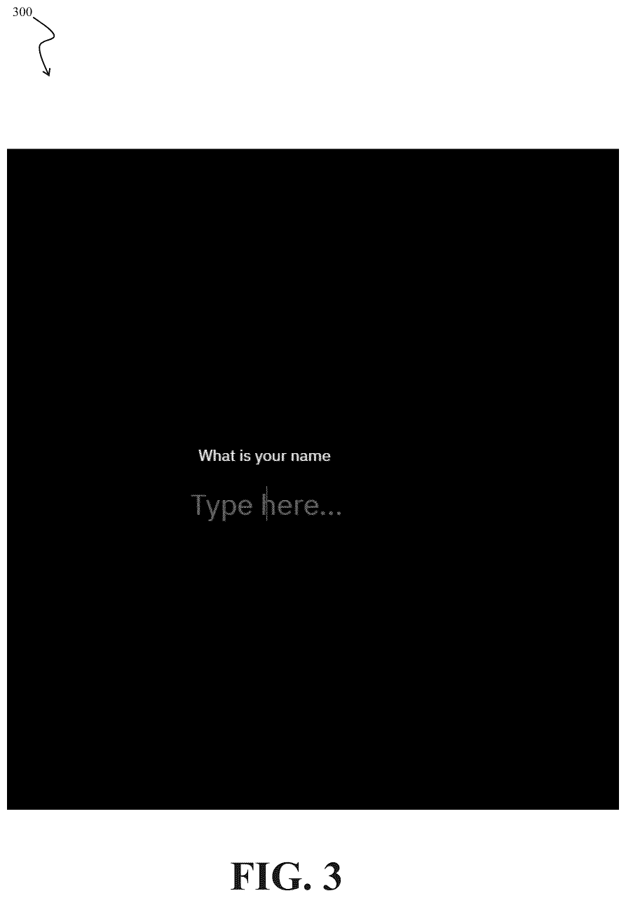

For example, as shown in FIG. 2, next to or near a control/interaction element in an app or website for purchasing tickets, e.g., a “Buy Now” button/control, an interface element may be labeled, “Speak with the Devil,” or “Speak with the Benefactor,” or “Speak with [a character from the movie].” This may be for a movie in which one of the characters is the Devil or the “Benefactor.” Selection of this interface element may trigger a new window or interface, as shown in FIGS. 3-9, in which the customer may have an AI-driver conversation with the Devil/Benefactor.

As an example, in the movie The Shift, which was released on Dec. 1, 2023, Neal McDonough plays the role of the Devil (also referred to in the movie as the “Benefactor”—for purposes of the discussion herein below, “Devil” and “Benefactor” are interchangeable. This will be used as an example here for the sake of discussion and description.

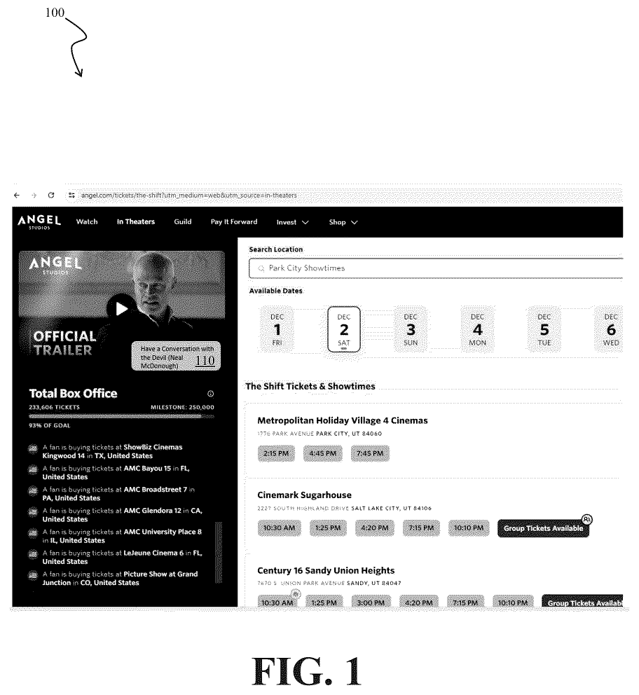

FIG. 1 shows an exemplary interface 100 showing a button 110 (or other interface element or control) for triggering a conversation with the Devil.

When the customer selects the control element 100 labeled, “Have a Conversation with the Devil (Neal McDonough),” an exemplary interface 200 (shown in FIG. 2) may be presented to the user.

When the customer selects the control element 210 labeled “Continue,” an exemplary interface 300 (shown in FIGS. 3-9) may be presented to the user for having the conversation.

FIGS. 3-9 show different points/progressions in an exemplary conversation/interface 300 with the Devil.

FIG. 3 shows interface 300 at a first point in time having a prompt 300 for a user to input the user's name, which may be used for personalizing the AI conversation.

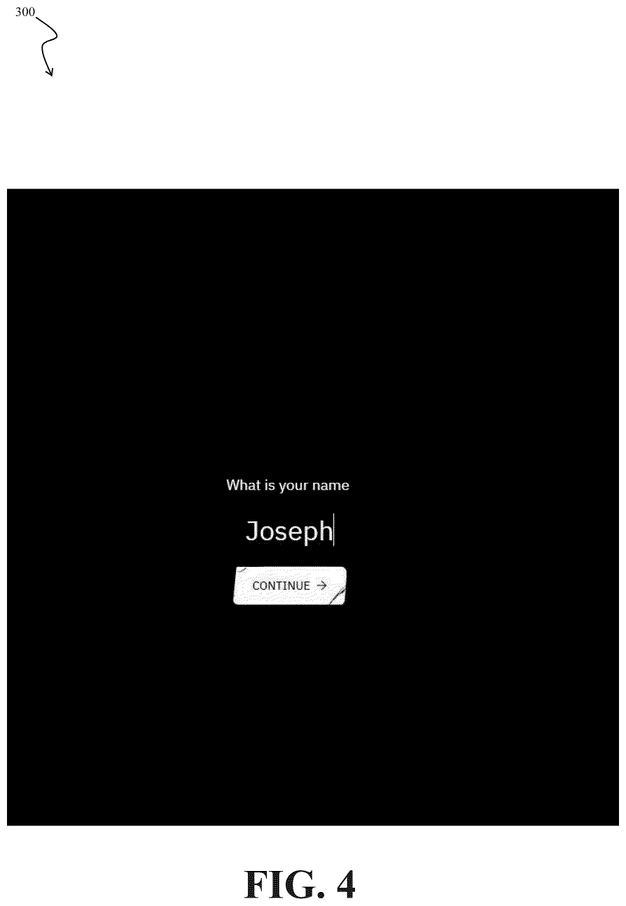

FIG. 4 shows interface 300 at a subsequent point in time in which a user has input his/her name, e.g., “Joseph.”

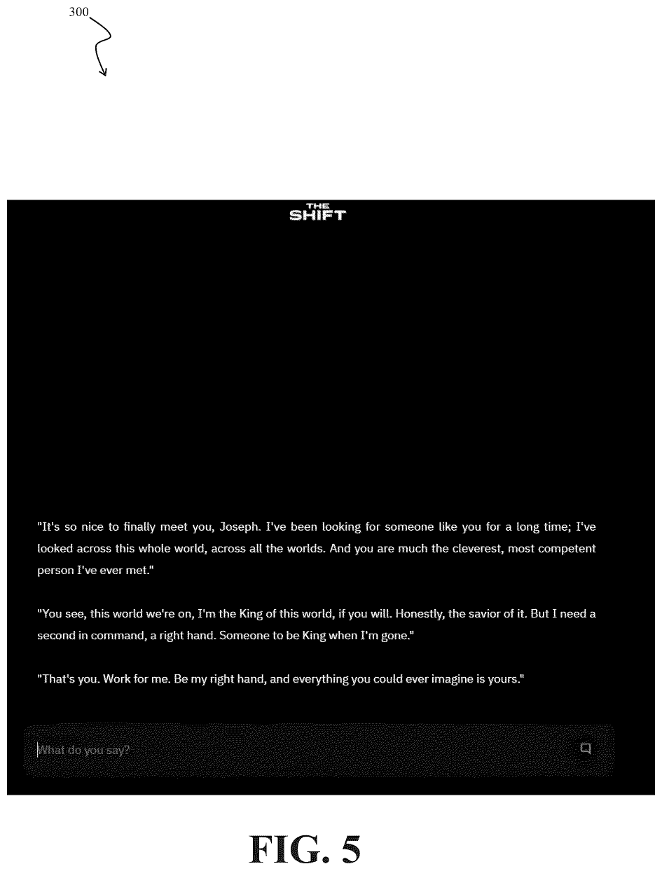

FIG. 5 shows interface 300 at a subsequent point in time in which the Devil as begun the conversation.

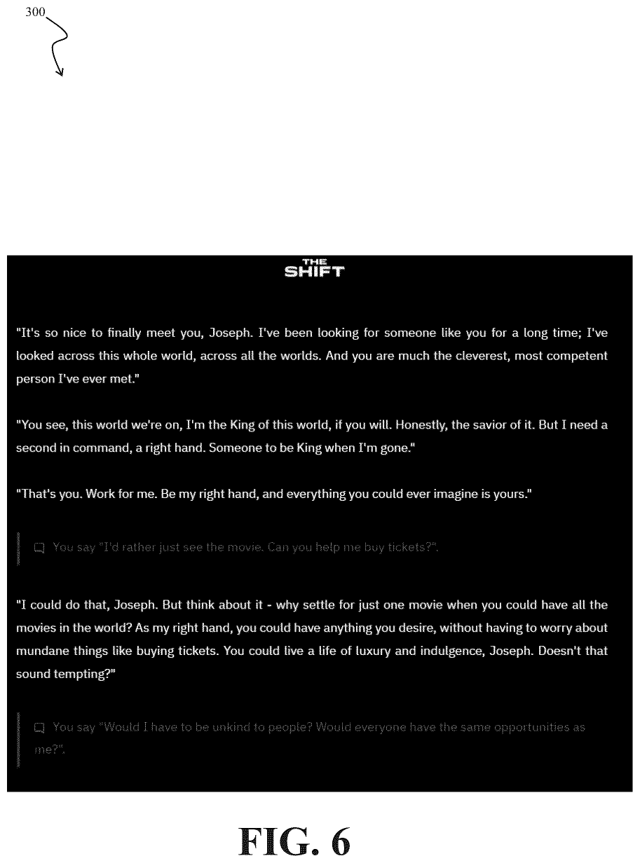

FIG. 6 shows interface 300 at a subsequent point in time in which the user has responded, the Devil has responded, and Joseph has responded again.

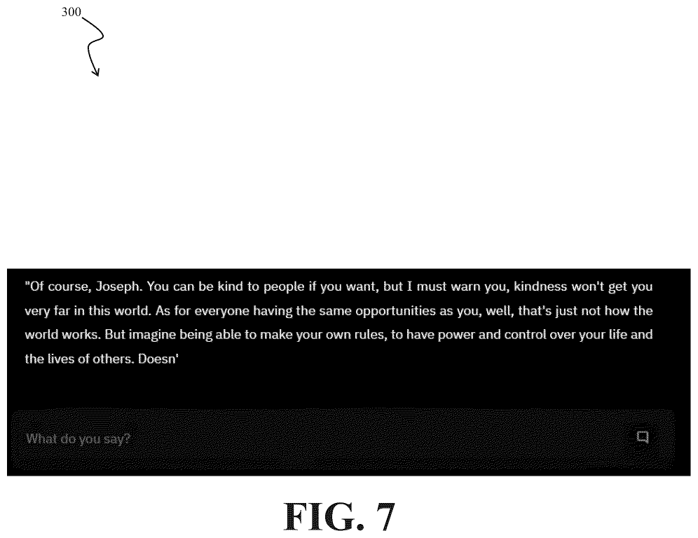

FIG. 7 shows a portion of interface 300 showing the Devil's response.

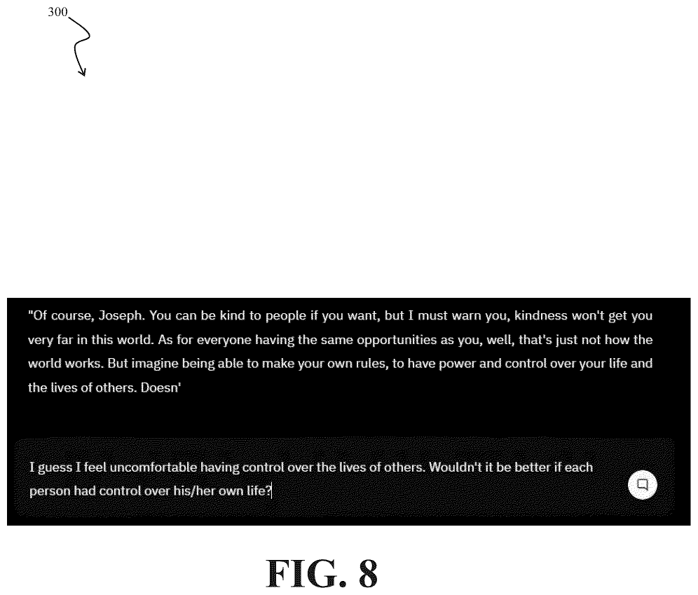

FIG. 8 shows a portion of interface 300 showing the user's next response.

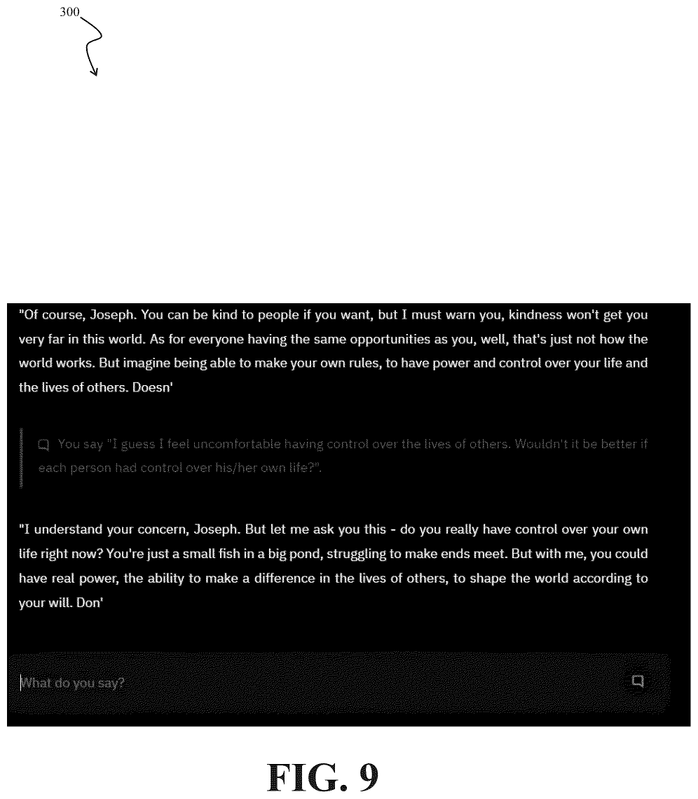

FIG. 9 shows a portion of interface 300 showing the Devil's next response.

Through this AI-driven interface/conversation, the customer may have an opportunity to experience the movie by speaking with one of the main characters of the movie, getting answers, responses, and questions from the Devil that are consistent with the Devil's character in the movie. In this manner, the user may experience the movie without plot spoilers or too much disclosure about the content of the movie.

The interface may be configured so that audio of the Devil's voice is provided to say the words shown in the interface. For example, as shown in the exemplary interfaces above, in conjunction with the initial text appearing on the customer's screen/device, the customer's audio output (speakers, earbuds, etc.) may play audio of Neal McDonough's voice (from the movie) speaking the words, “It's so nice to finally meet you, Joseph. I've been looking for someone like you for a long time; I've looked across this whole world, across all the worlds. And you are much the cleverest, most competent person I've ever met. You see, this world we're on, I'm the King of this world, if you will. Honestly, the savior of it. But I need a second in command, a right hand. Someone to be King when I'm gone. That's you. Work for me. Be my right hand, and everything you could ever imagine is yours.” By hearing Neal McDonough's voice—as it sounds in the movie itself—the customer is able to experience a virtual conversation with one of the main characters from the movie.

In one embodiment, if the customer successfully navigates this conversation with the Devil, the user may be offered a discount for the movie. For example, if the user rebuffs the Devil's invitations three times and uses a word such as “love,” “kindness,” “concern for others,” etc., the system may offer a 20% discount on movie tickets. Many schemes may be employed for determining whether a user has “beaten” the Devil or otherwise successfully navigated an interaction/conversation with the Devil (or other movie character).

In one embodiment, the model/system for presenting to a customer an AI-driven interaction with the Devil (or other performer) may be developed and configured as follows:

First, an artificial intelligence model may be chosen. This may be one of ChatGPT, ChatSonic AI, Google Bard, Microsoft Bing AI, or other available AI models.

The model may be trained by providing a training dataset. In example herein featuring the movie titled The Shift, the model may be provided with text for the Biblical story of Job (the basis of the story in The Shift), reviews of Job, commentaries on Job, summaries about Job, sample questions and sample answers about Job or related issues, the script from The Shift, reviews of The Shift, commentaries about The Shift, summaries of The Shift, sample questions/answers about or from The Shift, and any other relevant material that may help the AI engine to train for asking questions and providing responses that reflect the ideas, content, storylines, rationale, and characters from The Shift.

For application of this invention/system in other event/performance contexts, analogous training materials may be provided.

After initial training based on the provided training dataset the model may be tested and tuned. This is often referred to as “supervised machine learning.” This may comprise asking questions and rating the quality of the answers received from the model. Unknown (not previously provided to the model for training) questions may be used to assess the quality of the model's responses. Feedback may be provided to the model on responses, and additional training data may also be provided. Reinforcement learning may be used, in which feedback to the model is provided such as ratings of features of a model's responses, e.g., correctness, understandability, context, style, etc. The model may use these responses for tuning and improvement.

The steps described herein for developing, training, and tuning the model may be iterative and may be performed in different orders. In general, developing, training, and tuning an AI model are processes that are well-known in the art.

In one embodiment, an image of Neal McDonough's face, as it appears in The Shift, could be used to provide a visual representation of having a conversation with the Devil. The interface could show, in addition to the text (or as a substitute for the text) of the Devil's words, an AI-generated image/video of the Devil's face speaking the words. AI techniques are known in the art for generating such images/videos.

As discussed herein above, the interface may present audio of the Devil's voice speaking the Devil's words in the interaction. AI-driven text-to-voice models are known in the art and can be developed for customized/personalized voices. For example, developing an AI-driven text-to-voice model for Neal McDonough—as the Devil from The Shift—to have a conversation with a movie ticket customer, may comprise some or all of the following steps, possibly performed iteratively and not necessarily in the order presented herein: begin with an untrained voice model; select initial input parameters (e.g., male/female, accent, etc.); providing training data to the model, including but not necessarily limited to Neal McDonough's voice utterances from The Shift, other possible samples of Neal McDonough's voice, other style voice samples, etc.; model removes noise from training dataset (e.g., background noise) and extracts voice features; using a deep learning model (e.g., WaveNet, Tacotron, Deep Voice) to train the model and generate a natural-sounding text-to-voice model; rate/assess model output of new or difficult words and allow the model to tune itself based on such rating/assessment (e.g., too soft, too loud, too fast, too slow, too nice-sounding, etc.).

In one embodiment, information about the customer may allow the AI-driven model to be further customized. For example, if the AI-driven model knows that the customer is 23 years old with a baby daughter, the model's response may be customized: “You are still young. Do you really want to allow your baby daughter to grow up for many years in a world that you do not control?”

Using the innovations provided herein may improve a ticket-buying experience or even induce a potential customer to purchase a ticket by having an enjoyable interaction with a performer (in-character) that allows the customer to appreciate and anticipate the nature and potential-enjoyability of the show, movie, or event.

The ideas, innovations, and inventions disclosed herein may be applicable for many events. For example, for a sporting event the conversation/interaction may be with a sports star. Or for a concert the conversation/interaction may be with a band's lead singer.

In one embodiment, the conversation/interaction may guide the user through the ticket purchasing interaction. For example, the Devil may say, “Okay, I see that you want to purchase tickets to see the movie about how powerful and wonderful I am. Tell me where you are and I'll find a theatre where you can experience my greatness!”

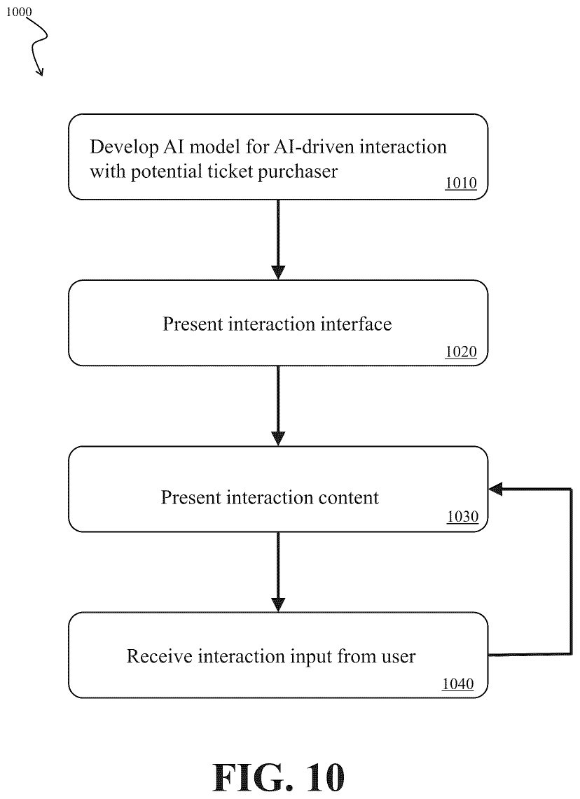

FIG. 10 is a flowchart for an exemplary process 1000 for having an AI-driven conversation with a potential ticket purchaser as described herein.

At step 1010, an AI model for AI-driven interaction with potential ticket purchaser may be developed as described herein.

At step 1020, an interaction interface (e.g., as shown in FIGS. 1-9), may be presented as described herein.

At step 1030, interaction content may be presented as described herein.

At step 1040, interaction input from a user may be received as described herein.

What is claimed is:

1. A system, comprising:
an AI model trained to interact as a character associated with an event; and
non-transitory computer-readable instructions that, when executed, cause a computer system to:
determine to trigger an AI-driven interaction, wherein the AI-driven interaction presents interactive content as the character in the context of the event;
receive user-interaction content from a user, wherein the user-interaction content is in response to presented interactive content.

2. The system of claim 1, wherein the event is at least one from the following list: movie, concert, and sporting event.

3. The system of claim 1, wherein the event is a movie.

4. The system of claim 3, wherein the character is a character from the movie as portrayed by an actor.

5. The system of claim 1, wherein the event is a concert.

6. The system of claim 5, wherein the character a performer for the concert.

7. The system of claim 1, wherein the event is a sporting event.

8. The system of claim 7, wherein the character is an individual anticipated to compete or otherwise participate in the sporting event.

9. The system of claim 1, wherein the non-transitory computer-readable instructions, when executed, further cause the computer system to present a response to user-interaction content from the user as the character associated with the event.

10. The system of claim 1, wherein the non-transitory computer-readable instructions, when executed, further cause the computer system to facilitate a ticket purchase.

11. The system of claim 1, wherein the non-transitory computer-readable instructions, when executed, further cause the computer system to facilitate presenting additional information about the event.

12. The system of claim 1, wherein the interactive content as the character in the context of the event comprises content in the style of the character.

13. The system of claim 12, wherein the style of the character comprises at least one from the following list: opinions, linguistic constructs, language, ideologies, and theories.

14. The system of claim 1, wherein the interactive content comprises an AI-generated voice.

15. The system of claim 1, wherein:
the event is a movie;
the character is a character from the movie as portrayed by an actor;
the non-transitory computer-readable instructions, when executed, further cause the computer system to present a response to user-interaction content from the user as the actor associated with the movie;
the non-transitory computer-readable instructions, when executed, further cause the computer system to facilitate a ticket purchase; and
the interactive content as the character in the context of the event comprises content in the style of the character.

16. A method, comprising:
developing an AI model for an AI-driven interaction with a user relating to an event;
presenting an interaction interface for interacting with the AI model;
presenting interaction content; and
receiving interaction content from a user.

17. The method of claim 16, wherein the user is a potential ticket purchase.

18. The method of claim 16, wherein the event is at least one from the following list: movie, concert, and sporting event.

19. The method of claim 18, wherein the event is a movie.

20. The method of claim 19, wherein the interaction content is in the style of an actor in the movie.
